(19) United States
(12) Patent Application Publication
(10) Pub. No.: US 2026/0049043 A1
(43) Pub. Date: Feb. 19, 2026

(54) STABLE NANO NITROGEN-PHOSPHOROUS CONTAINING FERTILISER AND METHOD OF MANUFACTURE THEREOF

(71) Applicant: INDIAN FARMERS FERTILISER COOPERATIVE LIMITED, New Delhi (IN)

(72) Inventors: Arunachalam LAKSHMANAN, New Delhi (IN); Udai Shanker AWASTHI, New Delhi (IN); Yogendra KUMAR, New Delhi (IN); Birinder SINGH, New Delhi (IN); Deepak Gajanan INAMDAR, New Delhi (IN); Tarunendu SINGH, New Delhi (IN)

(73) Assignee: INDIAN FARMERS FERTILISER COOPERATIVE LIMITED, New Delhi (IN)

(21) Appl. No.: 19/103,850

(22) PCT Filed: Nov. 9, 2023
(86) PCT No.: PCT/IN2023/051041

§ 371 Date: Feb. 14, 2025

(30) Foreign Application Priority Data
Feb. 8, 2023 (IN) 202311008037

(51) Int. Cl. C05G 5/23; B82Y 30/00; C05B 7/00

(52) U.S. Cl. CPC C05G 5/23; C05B 7/00; B82Y 30/00

(57) ABSTRACT

Stable liquid nano Nitrogen-Phosphorous Fertilisers are provided wherein nitrogen is in the range of 3-9% (w/w) and phosphorous (expressed in terms of P₂O₅) is in the range of 6-18% (w/w), wherein N:P (as P₂O₅) ratio ranges from 1:1 to 1:6. Sonicated urea in solution is judiciously reacted with Mono Ammonium Phosphate (MAP) followed by tailored treatment of the resulting nitrogen-phosphorous chemical entities with polysorbates and polymers, resulting in nano fertilisers having significant nitrogen & phosphorous uptake and use efficiency as compared to conventional bulk nitrogen-phosphorous fertilisers including DAP. The nano fertilisers exhibit stability at temperatures up to 50° C. without gelling. phase separation and precipitation during storage. The hydrodynamic diameter of the particles is less than 100 nm. with ph ranging between 3 and 7. These fertilisers increase vigour index of major crops such as paddy, groundnut and green gram upon seed treatment and also demonstrates significant field efficacy on paddy.

### FIELD OF THE INVENTION

The present invention relates to stable liquid fertiliser compositions containing nano clusters of Nitrogen and Phosphorous in high concentrations, including di-ammonium phosphate (DAP) and the method of manufacture thereof.

### BACKGROUND OF THE INVENTION

The requirements for N and P-based fertilisers are expected to reach 137.4 and 52.9 million tons (Mt) by 2030 (OECD-FAO 2020). More particularly, the demand for the global requirement for di-ammonium phosphate (DAP) by 2025, would be 30 million metric tonnes (statista.com; Luca Fernandez, 2022). Nutrient Use Efficiency (NUE) in current fertilization practices involving conventional fertilisers, is 30-40% for N-fertilisers and 18-20% for P-based fertilisers. Conventionally, P in fertilizers is expressed in terms of as P₂O₅. It is recognised that only a fraction of these nutrients is effectively utilised for crop growth and yield. Further, the Nitrogen-phosphorus containing fertilisers that are currently being released into the environment result in eutrophication and groundwater contamination, threatening environmental resources, public health, and economic investments; while the nutrient excess favours spread of pests and weeds. The thrust in sustainable agriculture is therefore to reduce nutrient losses by at least 50% while ensuring no deterioration of soil fertility and negative impact on biodiversity and climate.

The use of nanotechnology in the production of enhanced efficiency fertilisers (EEFs) has been identified as an appropriate trajectory to address this societal need. Earlier attempts have provided liquid fertilizer compositions in the market place claiming to contain nano DAP, wherein the N and P concentrations are between 1 to 2% and 3 to 5% respectively. It is desirable to provide stable liquid fertilizer compositions containing nano clusters of N and P with higher N >3% and P (as P₂O₅)>6% content, at least up to N˜9% and P˜18%. This is because the nutritional requirement in particular, the N, P and K of crops varies widely. Hence, developing nano nutrient containing liquid fertiliser compositions with higher nitrogen and phosphorous content is preferred to achieve better results in different crops.

The challenge has been to provide liquid fertilizer compositions containing nanoclusters of N and P, that demonstrate stability on storage at temperatures up to 50° C. wherein, the nano clusters do not agglomerate, precipitate or phase separate. Additionally, it has been observed that the pH of such compositions does not exhibit desired stability.

There is therefore an unmet need to provide stable liquid fertilizer compositions containing nano clusters of N and P with N>3% and P (as P2O5)>6%.

This requires to develop liquid formulations containing nano clusters of N and P, that ensure physical and chemical stability even under higher temperatures (preferably up to 50° C.) during transport and storage to ensure commercial success of the product and better field efficacy in all crops. The product of the present invention has addressed these two major challenges in nano-fertilizer formulations such as higher nutrient content and enhanced stability.

The present invention provides stable nano clusters of Nitrogen and Phosphorous containing liquid fertilizer compositions (such as DAP) with N at least up to 9% and P (as (P₂O₅) at least up to 18% that has eluded the prior art. The product of the present invention has the desired physical and chemical stability at temperatures of at least 50° C. Further, the fertilisers of the present invention have significant nitrogen & phosphorous uptake and use efficiency as compared to conventional bulk nitrogen-phosphorous fertilisers including DAP.

### OBJECTS OF THE PRESENT INVENTION

The main object of the present invention is to provide stable liquid fertiliser compositions containing nano clusters of Nitrogen and Phosphorous with N in the range of 3-9% and P (as P₂O₅) in the range of 6-18% including di-ammonium phosphate (DAP) demonstrating significant nitrogen & phosphorous uptake and use efficiency as compared to conventional bulk nitrogen-phosphorous fertilisers including DAP.

Another object of the invention is to provide liquid fertiliser containg stable nano clusters of Nitrogen-Phosphorous such as DAP using “green technologies”.

Yet another object of the invention is to provide the said fertiliser wherein the size of the nano clusters is maintained<100 nm during storage.

Yet another object of the present invention is to provide the said fertiliser that is stable without phase separation and precipitation during storage.

Yet another object of the present invention is to provide the said fertiliser demonstrating high absorption on foliar spraying.

Yet another object of the present invention is to provide the said fertiliser with high nutrient use efficiency and seedling vigour when applied through seed treatment and seedling dip.

Yet another object of the invention is to provide commercially cost effective scalable process for manufacture of the said fertiliser.

### SUMMARY OF THE INVENTION

The present invention provides stable liquid fertiliser compositions containing nano clusters of Nitrogen-Phosphorous containing fertiliser such as DAP with a maximum nitrogen and phosphorous content of 3-9% (w/w) and 6-18% (w/w) respectively demonstrating significant nitrogen & phosphorous uptake and use efficiency as compared to conventional bulk nitrogen-phosphorous fertilisers including DAP.

The process involves judiciously reacting hydrolyzed aqueous urea solution with Mono Ammonium Phosphate (MAP) in the presence of polyphosphates followed by tailored treatment of the resulting nitrogen-phosphorous chemical entities with polysorbates and polymers. Further, the fertiliser compositions of the present invention have proved to have desired physical and chemical significant nitrogen & phosphorous uptake and use efficiency as compared to conventional bulk nitrogen-phosphorous fertilisers.

### BRIEF DESCRIPTION OF FIGURES

FIG. 1 Particle Size Distribution of liquid fertiliser (N: P-1:2) of example 1 at 1° C. after 170 hours of storage;

FIG. 2: Particle Size Distribution of liquid formulation (N: P-1:2) of example 1 at 37° C. after 170 hours of storage;

FIG. 3: Particle Size Distribution of liquid fertiliser (N: P-1:2) of example 1 at 45° C. after 170 hours of storage;

FIG. 4: Particle Size Distribution of liquid fertiliser (N: P-1:2) of example 1 at 50° C. after 170 hours of storage;

FIG. 5: XRD of DAP (Monoclinic crystal system);

FIG. 6. XRD of recrystallized solids from liquid fertiliser of example. 1 (N: P-1:2);

FIG. 7. XRD of recrystallized solids from liquid formulation of example.2 (N: P-1:2.4);

FIG. 8. XRD of recrystallized solids from liquid fertiliser of example.3 (N: P-1:1.8);

FIG. 9: XRD of recrystallizedsolids from liquid fertiliser of example.4 (N: P-1:2.5);

FIG. 10: XRD of recrystallized solids from liquid fertiliser of example.5 (N: P-1:3.57);

FIG. 11: 1.Blue Region (430-490 nm); 2. Red Region (620-750 nm) Effect of Conventional DAP treatment on PSI and PSII in Rice;

FIG. 12: 1.Blue Region (430-490 nm); 2. Red Region (620-750 nm) Impact of liquid fertilizer of example 3 (N: P-1:1.8) on PSI and PSII in Rice;

FIG. 13: Dynamic Surface tension of conventional DAP solution (2%) on maize leaf;

FIG. 14: Surface tension of liquid fertilizer of example 3 (N: P-1:1.8) on maize leaf;

FIG. 15: Contact angle of conventional DAP (2% solution) on Maize leaf;

FIG. 16: Contact angle of liquid fertilizer of example 3 (N: P-1:1.8-250 times diluted) on Maize leaf.

### DETAILED DESCRIPTION OF THE INVENTION

The present invention provides biosafe stable liquid fertiliser compositions containing nano clusters of nitrogen and phosphorous having N:P (as P₂O₅) ratio of 1:1 to 1:6 wherein the hydrodynamic diameter of the particles are less than 100 nm. The liquid nano fertiliser of the present invention is stable at least up to 50° C. without gelling, phase separation and precipitation during storage. The product of the present invention is stable at least for 12 months. The pH ranges between 3 and 7 during storage. The liquid fertiliser compositions of the present invention containing nano clusters of nitrogen and phosphorous, demonstrate increased vigour index of major crops such as paddy, groundnut and greengram upon seed treatment. Further, the said liquid fertiliser compositions demonstrate significant field efficacy on paddy.

Hydrolyzed aquous solution of urea (4-15%) is reacted with a solution of mono ammonium phosphate (25-35%) in the presence of polyphosphates (1-3%), optionally adjusting the pH of the resulting solution to <4 and mixing a non-ionic surfactant or poly-ether derivatives (0.3-1.5%) in the solution resulting in Component 1. In a separate step, a solution of a polymer (0.3-1.5%) and oligosaccharide (0.01-1%) is prepared followed by optional addition of amino acid or vitamins to result in Component 2. In a final step, components 1 and 2 are mixed with optional addition of buffers, anti-microbial agents as preservatives and defoamers.

The hydrolysis of urea is achieved by sonication, thermally, enzymatically or by any known means. The hydrolysis is preferably done by sonication. The polyphosphate is preferably sodium tripolyphosphate. The non-ionic surfactant is selected from polyethers and ethoxylated sorbitan surfactants alone or in combination. Polysorbate 20 and Polysorbate 80 are preferably used. Polymers such as gum arabic and pectin may be used. The oligosaccharide is preferably selected from Beta-cyclodextrin and dextrose. The polyethers are preferably selected from poly ethylene glycol and poly propylene glycol. The amino acids such as Glycine, Lysine and Glutamic acid are preferably used. The vitamins are preferably selected from L-ascorbic acid (vitamin C) and α-tocopherol (vitamin E).

Antimicrobials such as Streptomycin and Benzalkonium chloride may be used. Preservatives such as sulphur dioxide are optionally added.

The resulting nano Nitrogen-Phosphorous containing fertiliser exhibit particle sizes of <100 nm and are stable on prolonged storage at 50° C. The nano formulations of the present invention having HLB values ranging from 10.0 to 13.0 exhibit desirable contact angle of the droplets on diverse substrates such as plant leaves on spraying thereby enhancing their absorption efficiency, photosynthetic efficiency and bio efficacy when used under different field application methods such as seed treatment, seedling dip and foliar spray.

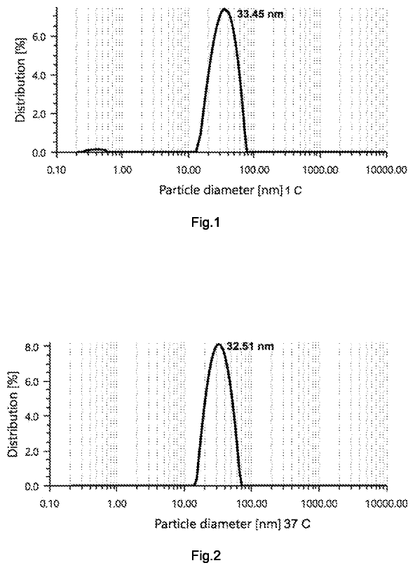

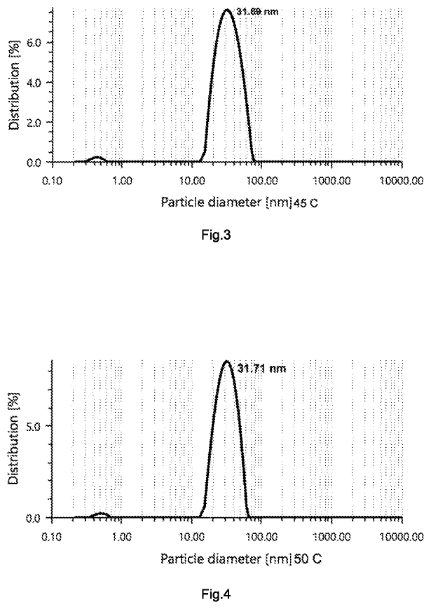

The particle size distribution of the fertiliser of the present invention at dilution of 1:10 in deionized water was measured by Dynamic Light Scattering using Particle Size Analyzer (model: Litesizer 600). The hydrodynamic diameter ranged from 30-50 nm and a zeta potential was higher than −10 mV. The particle size distribution of these fertiliser of the present invention remained stable without gelling, phase separation and precipitation even when stored at 1° C., 37° C., 45° C. and 50° C. for 170 hours. The results of particle size distribution of representative examples of the present invention are presented in FIGS. 1 to 4. Table 1 summarises some of the characteristics of the representative liquid fertiliser compositions of the present invention.

TABLE 1
Characteristics of the representative liquid fertiliser
compositions of the present invention containing
nano clusters of nitrogen and phosphorous

| S. No. | Parameter | Values |
|---|---|---|
| 1 | Particle Size (Hydrodynamic diameter) | 80% of particles |
| | | less than 100 nm |
| 2 | pH | 3.0 to 7.0 |
| 3 | Total Nitrogen as N; % (w/w) | 3-9 |
| 4 | Total Phosphorus as P₂O₅; % (w/w) | 6-18 |
| 5 | Zeta Potential | highier than −10 mV |
| 6 | Surface Tension | 25-30 N/m |

XRD of the recrystalised solids from the liquid fertiliser compositions of the present inventions match with the XRD reported for DAP (FIGS. 5-10). The space group is P21/c10 with lattice parameters, a=11.18 Å, b=6.03 Å, c=6.35 Å. α=y=90°; β=96.8°, which corresponds to the monoclinic crystal system (a≠b≠c; a=y-90°; β≠90°).

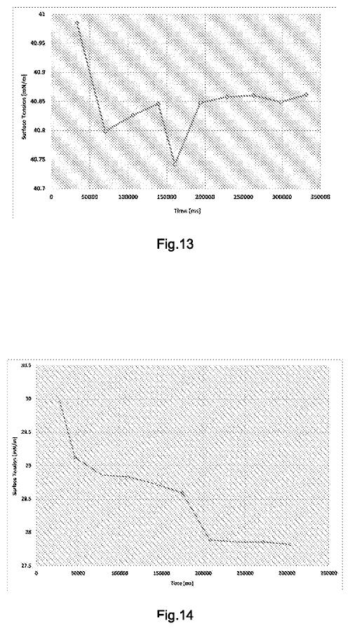

For any spray solution the most desired surface tension required for better wettability is 25-30 N/m and the surface tension of the nano urea spray solution falls within the range and demonstrates the desired drift potential resulting in uniform coverage during foliar spray. The surface tension of the liquid fertiliser compositions of the present invention are all in the desired range (FIGS. 13-14).

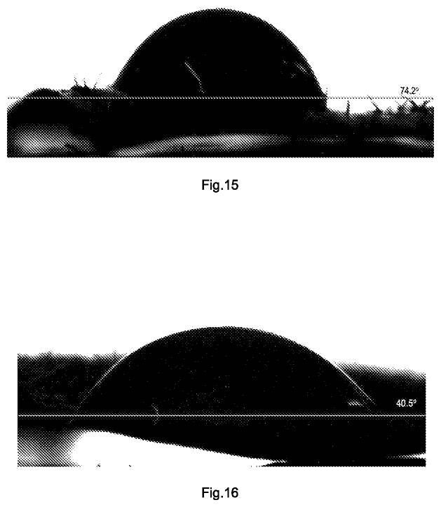

Leaves are classified as non-wettable, if contact angle θ>110°, and θ>150° for leaves are considered super hydrophobic. Similarly, leaves are considered as highly wettable if θ<90°. The contact angles of the liquid fertiliser compositions of the present invention is substantially <90° (FIGS. 15-16), and demonstrate super wettability, thereby ensuring superior uptake of nano nutrient clusters into the plant system.

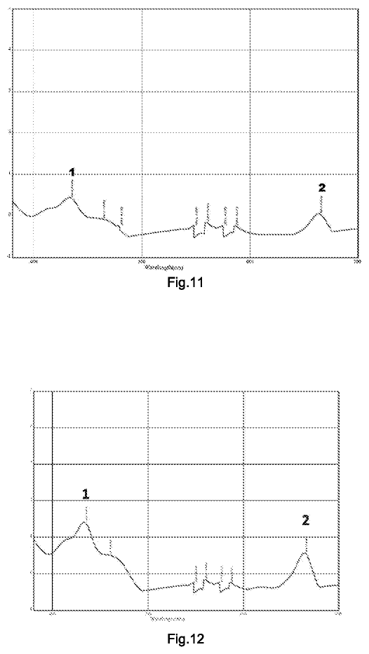

The expression of chlorophyll in blue and red region is higher in the case of the plants treated with the liquid fertiliser of the present invention as compared to those treated by conventional DAP (FIG. 11 and 12).

The liquid fertilisers of the present invention are confirmed to be biosafe and efficacious as is evident from their increased vigour index of major crops such as paddy, groundnut and green gram upon seed treatment.

The liquid fertiliser of the present invention were centrifuged at 3500 rpm for 20 min, no phase separation or sedimentation was observed in any of the preparations. Samples of the liquid fertiliser solutions of the present invention when stored at 50° C. for 50 days showed particle size distribution and zeta potential stability without any measurable physical changes. Further, storage at 40° C. for 6 months, demonstrated stability without any physical changes with variation in pH from 3.2 to 3.5; particle size distribution from 22.7 nm to 18.4 nm; zeta potential from −15.5 mV to −14.5 mV; N content from 8.03% to 8.02%, P (as P₂O₅) from 16.23% to 16.28%; microbial contamination nil; TDS from 32.70 ppt to 34.18 ppt.

The liquid fertilisers of the present invention increases the vigour index of major crops such as paddy, groundnut and greengram upon seed treatment. Further, the said liquid fertilisers demonstrate significant photosynthetic activity and field efficacy in paddy. These liquid fertilisers are eco-friendly as they are biosafe and do not exhibit any negative impact on beneficial organisms in agriculture such as parasitoids, predator and Indian honey bees.

The invention is illustrated with non-limiting examples.

### Example 1: Preparation of Liquid Fertiliser With N: P-1:2 With N and P (as P₂O₅) of 7% and 14% w/w.

Step 1; Preparation of Solution 1:112 kg of urea was dissolved in 650 litres of deionized water and subjected to sonication. 250 kg of mono ammonium phosphate and 25 kg of sodium tripolyphosphate was added with stirring to react with the sonnicated urea solution, followed by addition with stirring of 3 litres of polyethylene glycol.

Step 2; Preparation of Solution 2:3 kg of gum arabic was dissolved in 120 litres of deionized water followed by the sequential addition with stirring of 900 gm of beta-cyclodextrin, 0.5 kg of tryptophan and 1 kg of glutamic acid to obtain a clear solution.

Step 3: Solutions 1 and 2 were mixed with stirring; SO₂ was purged in the solution to attain a concentration of 300 ppm and the final volume was made up to 1000 litres with water to obtain the final liquid fertiliser composition.

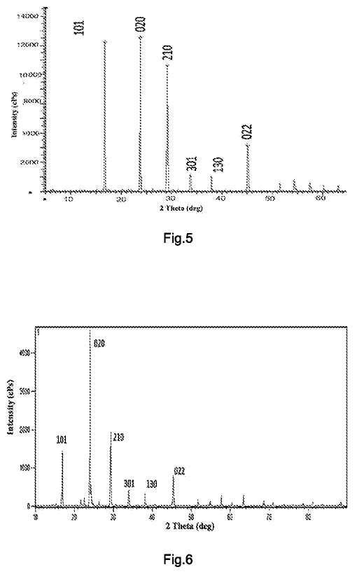

The particle size distribution showed that 80% of particles were less than 100 nm. The zeta potential was −15.6 mV. XRD of the recrystalised solids from the liquid fertiliser composition showed characteristics of a monoclinic system matching those of DAP (FIGS. 5 and 6).

### Example 2: Preparation of Liquid Fertiliser with N: P-1:2.4 with N and P (as P₂O₅) of 6.25% and 15.14% w/w.

Step 1; Preparation of Solution 1:90 kg of urea was dissolved in 600 litres of deionized water and subjected to sonication. 270 kg of mono ammonium phosphate and 25 Kg of sodium tripolyphosphate was added with stirring to react with the sonicated urea solution, followed by addition of 3 litres of Tween 20 with stirring.

Step 2; Preparation of Solution 2:3 kg of gum arabic was dissolved in 120 litres of deionized water followed by the sequential addition with stirring of 900 gm of beta-cyclodextrin, 0.5 kg of tryptophan and 1 kg of glutamic acid to obtain a clear solution.

Step 3: Solutions 1 and 2 were mixed with stirring; SO₂ was purged in the solution to attain a concentration of 300 ppm and the final volume was made up to 1000 litres with water to obtain the final liquid fertiliser composition.

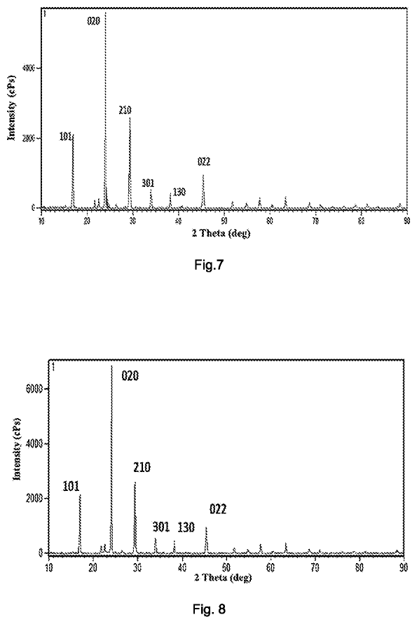

The particle size distribution showed that 80% of particles were less than 100 nm. The zeta potential was −16.0 mV. XRD of the recrystalised solids from the liquid fertiliser composition showed characteristics of a monoclinic system matching those of DAP (FIGS. 5 and 7).

### Example 3: Preparation of Liquid Fertiliser With N:P-1:1.8 With N and P (as P₂O₅) of 8.2% and 15.14% w/w.

Step 1; Preparation of Solution 1:140 kg of urea was dissolved in 600 litres of deionized water and subjected to sonication. 270 kg of mono ammonium phosphate and 25 kg of sodium tripolyphosphate was added with stirring to react with the sonicated urea solution, followed by addition with stirring of 2 litres of poly ethylene glycol and 0.5 litres of Tween 20.

Step 2; Preparation of Solution 2:5 kg of gum arabic was dissolved in 90 litres of deionized water followed by the sequential addition with stirring of 1 kg of beta-cyclodextrin, 0.5 kg of tryptophan and 1 kg of glutamic acid to obtain a clear solution.

Step 3: Solutions 1 and 2 were mixed with stirring; SO₂ was purged in the solution to attain a concentration of 300 ppm and the final volume was made up to 1000 litres with water to obtain the liquid fertiliser composition.

The particle size distribution showed that 80% of particles were less than 100 nm. The zeta potential was-18.4 mV. XRD of the recrystalised solids from the liquid fertiliser composition showed characteristics of a monoclinic system matching those of DAP (FIGS. 5 and 8).

### Example 4: Preparation of Liquid Fertiliser With N: P-1:2.5 With N and P (as P₂O₅) of 6% and 15% w/w

Step 1; Preparation of Solution 1:95 kg of urea was dissolved in 610 litres of deionized water and subjected to sonication. 272 kg of mono ammonium phosphate and 20 kg of sodium tripolyphosphate was added with stirring to react with sonicated urea solution, followed by addition with stirring of 5 litres of poly ethylene glycol.

Step 2; Preparation of Solution 2:3 kg of Pectin was dissolved in 120 litres of deionized water followed by the sequential addition with stirring of 500 gm of beta cyclodextrin, 0.5 kg of tryptophan and 1 kg of glutamic acid to obtain a clear solution.

Step 3: Solutions 1 and 2 were mixed with stirring; SO₂ was purged in the solution to attain a concentration of 300 ppm and the final volume was made up to 1000 litres with water to obtain the liquid fertiliser composition.

The particle size distribution showed that 80% of particles were less than 100 nm. The zeta potential was −17.2 mV. XRD of the recrystalised solids from the liquid fertiliser composition showed characteristics of a monoclinic system matching those of DAP (FIGS. 5 and 9).

### Example 5: Preparation of Liquid Fertiliser Containing N: P-1:3.57 with N and P (as P₂O₅) of 5.11% and 18.24% (w/w)

Step 1; Preparation of Solution 1:45 kg of urea was dissolved in 580 litres of deionized water and subjected to sonication. 330 kg of mono ammonium phosphate and 25 kg of sodium tripolyphosphate was added with stirring to react with the sonnicated urea solution, followed by addition with stirring of 4 litres of poly ethylene glycol.

Step 2; Preparation of Solution 2:4.6 kg of gum arabic was dissolved in 120 litres of deionized water followed by the sequential addition with stirring of 900 gm of dextrose, 2 kg of ascorbic acid and 2 kg of Glycine to obtain a clear solution.

Step 3: Solutions 1 and 2 were mixed with stirring; SO₂ was purged in the solution to attain a concentration of 300 ppm and the final volume was made up to 1000 litres with water to obtain the liquid fertiliser composition.

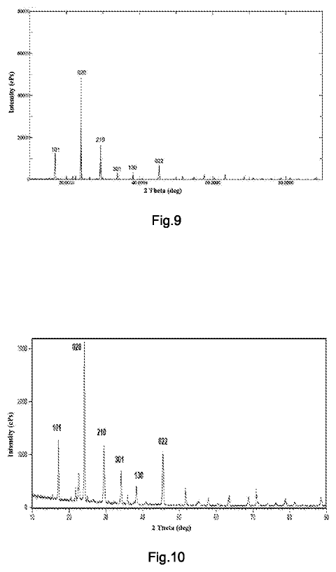

The particle size distribution showed that 80% of particles were less than 100 nm. The zeta potential was −15.8 mV. XRD of the recrystalised solids from the liquid fertiliser composition showed characteristics of a monoclinic system matching those of DAP (FIGS. 5 and 10).

### Example 6. Seed Vigour Test of Liquid Fertiliser of the Present Invention with N:P (as P₂O₅) of 1:2.5 (Example 4) and 1:2.4 (Example 2)

Seed vigour test was performed to assess the bioefficacy. Roll towel technique was used in which the seeds were tested for germination percentage, root length, shoot length, fresh weight and dry weight. 0.5% formulation of example 4 (1:2.5) (5 ml made up to one litre of water) was used to test the effect of nano N:P fertilisers of the present invention on seed vigour index in groundnut and green gram over control. Similarly, formulation of example 2 (1:2.4) (5 ml made up to one litre of water) was used to test the effect of nano N:P fertilisers of the present invention on seed vigour index in Maize and green gram over control.

The vigour index of the seedlings was estimated using the formula (Abdul baki and Anderson, 1973):

$$Root length ( cm ) + Shoot length ( cm ) \times Germination percentage .$$

Results are presented in Table.2 and 3.

TABLE 2
Effect of liquid fertiliser of the present invention
with N:P (1:2.5) of example 4 on seed vigour

| | Groundnut (Day 10) | | Green Gram (Day 7) | |
|---|---|---|---|---|
| | T1 | T2 | T1 | T2 |
| Characters | (Control) | (0.5%) | (Control) | (0.5%) |
| Germination % | 84 | 96 | 95 | 100 |
| Avg. Shoot | 11.8 | 15.3 | 13.75 | 18.76 |
| Length (cm) | | | | |
| Avg. Root | 7.9 | 8.6 | 22.10 | 27.84 |
| Length (cm) | | | | |
| Seed Vigour | 1654.8 | 2294.4 | 3405.75 | 4660 |
| Index | | | | |

*All values are mean of three replications

TABLE 3
Effect of liquid fertiliser of the present invention
with N:P (1:2.4) of example 2 on seed vigour

| | Maize (Day 7) | | Green Gram (Day 7) | |
|---|---|---|---|---|
| | T1 | | T1 | |
| Characters | (Control) | T2 (0.5%) | (Control) | T2 (0.5%) |
| Germination % | 92 | 100 | 89 | 98 |
| Avg. Shoot | 24.12 | 29.88 | 14.50 | 19.23 |
| Length (cm) | | | | |
| Avg. Root | 26.21 | 31.91 | 22.63 | 28.00 |
| Length (cm) | | | | |
| Seed Vigour | 4630.36 | 6179 | 3304.57 | 4628.54 |
| Index | | | | |

*All values are mean of three replications

### Example 7: Effect of the Sprayed Liquid Fertiliser of the Present Invention on Photosystem I And Ii in Rice

The blue (B) and red (R) light are the most effectively utilized wavelengths during plant photosynthesis because the absorption spectra of the photosynthetic pigments mainly focus on the B (400-500 nm) and R (600-700 nm) light spectra. In plants, chlorophyll a and chlorophyll b are the main photosynthetic pigments. Chlorophyll molecules absorb blue and red wavelengths. The liquid fertiliser of the present invention of example 3 (N:P −1:1.8), was sprayed on rice foliage during active vegetative stage and the samples were collected and chlorophyll were extracted based on Amon 1949 and were subjected to spectroscopic analysis and OD was measured at 645 and 663 nm. The results are presented in FIGS. 11 and 12. The results indicate that the expression of chlorophyll in blue and red region is higher in the case of the plants treated with the liquid fertiliser of the present invention as compared to those treated by conventional DAP.

### Example.8: Study of Surface Tension and Dynamic Contact Angle of the Liquid Fertiliser of the Present Invention of Example 3 (N:P-1:1.8) on Maize leaf

Force tensiometer—Kruss (Tensiio K100) was used to measure the surface tension of the liquids that utilizes Du Nouy ring method (ASTM D971). Surface tension of conventional DAP (2% solution) was 41 N/m (FIG. 13), whereas surface tension of spray solution of example 3 of the present invention was 27.8 N/m (FIG. 14).

Static contact angle of the spray solution of liquid fertiliser of the present invention and conventional DAP (2% solution) on maize leaf was measured using sessile drop technique (Marmur 2006; Erbil 2014; Wan et al. 2014). The contact angle of 2% solution of bulk commercial DAP on Maize leaf was 74.2° (FIG. 15); the contact angle of liquid fertiliser spray solution of example 3 was 40.5° (FIG. 16). The significantly reduced contact angle of the liquid fertiliser spray solution of example 4 shows its higher effectiveness as compared to the spray of commercial DAP solution (2%).

### Example 9. Field Efficacy Study of the Liquid Fertiliser of the Present Invention N:P (1:2.5) of Example 4

Experiment was conducted on paddy variety MTU-1224 during kharif 2021 to assess the field efficacy of the liquid fertiliser of the present invention N:P (1:2.5) Higher grain yield of 6707 kg/ha was recorded in the plot receiving 50% P through DAP (100% N % K RDF) where seedling dipping @ 0.5% of the liquid fertiliser of the present invention N:P (1:2.5) was done followed by foliar spray @ 2 ml/litre of water at 20-25 days after transplanting (DAT) over yield of 5537 kg/ha recorded in RDF (NPK-90:60:60 Kg/ha) plot with 100% P application.

### Example.10: Biosafety Studies of the Liquid Fertiliser of the Present Invention N:P (1:2.5) of Example 4 Against the Natural Enemies of Parasitoid, Predator, and Indian Honeybee

The bio-safety laboratory tests were performed based on OECD and DBT guidelines.

Adult Emergence of Trichogramma chilonis

The egg parasitoid Trichogramma chilonis (Tricho card) was obtained from the bio-control unit, Department of Agricultural Entomology, Tamil Nadu Agricultural University, Coimbatore. The biosafety of the liquid fertiliser composition of example 4 with N:P 1:2.5 was evaluated against T. chilonis, an effective egg parasitoid. In the laboratory study, there were six treatments with four replications. The biosafety experiment was conducted where the parasitized egg cards were sprayed with the liquid fertiliser of the present invention N:P (1:2.5) using an atomizer. Distilled water was sprayed on the untreated check. The treated egg cards were shade-dried for 10 minutes and then kept in an insect bio-assay box. The number of adult parasitoids that emerged 48 hours after treatment (HAT) was recorded, and the percentage of adult emergence was worked out using the formula,

$$Adult emergence ( \% ) = \frac{Number of wasps emerged}{Total number of parasitized eggs in one {cm}^{2} trichocard} \times 100$$

The data obtained from the laboratory experiments were analysed using a completely randomized design. The data on mortality per cent were transformed into arc sine values. Further, the treatment means were statistically differentiated by performing Duncan Multiple Range Test (DMRT) at p<0.05 levels.

The liquid fertiliser of the present invention N:P (1:2.5) was evaluated against the egg parasitoid, Trichogramma chilonis at five different concentrations of 2000 ppm, 4000 ppm, 6000 ppm, 8000 ppm, and 10000 ppm. The results are detailed in Table.4. The bio-safety experimental result exhibited that 100 per cent adult emergence of the egg parasitoid T. chilonsis was observed in the 2000 ppm concentrations of the liquid fertiliser of the present invention N:P (1:2.5) after 48 hours of treatment (48 HAT), whereas in the control, 100 percent adult emergence of T. chilonis was observed.

The biosafety study's statistical analysis revealed that there is no significant difference between the two treatments. At 48 hours after treatment (48 HAT), 4000 ppm and 6000 ppm the liquid fertiliser of the present invention N:P (1:2.5) showed 99.37 and 98.87 percent adult emergence, respectively, compared to 100 percent in the control. The experimental result revealed that there was no significant difference between the treatments and that they were similar. Similarly, 8000 ppm and 10000 ppm of the liquid fertiliser of the present invention N:P (1:2.5) showed that 98.50 and 97.50 per cent adult emergence were observed in the 48 HAT (Table 4)

TABLE 4
Biosafety of liquid formulation of the liquid fertiliser
of the present invention (N:P (1:2.5) of example 4 against
Trichogramma chilonis egg parasitoid

| | | Dosage | | |
|---|---|---|---|---|
| | | (Conc. of | Adult emergence | |
| S. No | Treatments | NDAP/litre) | (%) | |
| 1 | Example 4 (N:P | 2000 ppm | 100 | (88.83)^{a} |
| | 1:2.5) | | | |
| 2 | Example 4 (N:P | 4000 ppm | 99.37 | (85.45)^{b} |
| | 1:2.5) | | | |
| 3 | Example 4 (N:P | 6000 ppm | 98.87 | (83.90)^{b} |
| | 1:2.5) | | | |
| 4 | Example 4 (N:P | 8000 ppm | 98.50 | (82.96)^{bc} |
| | 1:2.5) | | | |
| 5 | Example 4 (N:P | 10000 ppm | 97.50 | (80.90)^{c} |
| | 1:2.5) | | | |
| 6 | Untreated control | — | 100 | (88.83)^{a} |

| | |
|---|---|
| S. Ed | 1.11 |
| C.D @0.5% level | 2.33 |
| C.V | 1.84 |

*mean value followed by alphabets are significantly different by DMRT (P = 0.05). ^{a, b, c and bc}denotes the difference in significance between the treatments.

Ovicidal Effect of the Liquid Fertiliser of the Present Invention (Example 4) N:P (1:2.5) on the Eggs Of C. zastrowil

The green lacewing, Chrysoperla zastrowii silemii eggs were obtained from the Bio-Control Laboratory, Department of Agricultural Entomology, Tamil Nadu Agricultural University, Coimbatore, and used in the laboratory for the bio-safety test. To assess the effect on the eggs of C. zastrowii, the brown paper strips containing stalked eggs were treated with the liquid fertiliser of the present invention N:P (1:2.5) using an atomizer. Each treatment was replicated four times with 20 eggs per replication. The eggs sprayed with distilled water was served as control. The number of grubs hatched from each treatment were recorded, and the per cent hatchability was worked out using the formula,

$$Per cent hatchability = \frac{Number of grubs hatched}{Total number of eggs} \times 100$$

The data obtained from the laboratory experiments were analysed in a completely randomized design. The data on mortality per cent were transformed into arc sine values. Further, the treatment means were statistically differentiated by performing Duncan Multiple Range Test (DMRT) at p<0.05 levels.

Five concentrations of the liquid fertiliser of the present invention N:P (1:2.5), as well as a control (water), were tested against the eggs of the green lacewing, Chrysoperla zastrowi sillemi, in the biosafety laboratory. The present study result showed that 1.75 per cent mortality and 98.25 per cent egg hatchability were recorded at 10000 ppm of the liquid fertilisers of the present invention with N:P (1:2.5), whereas the control treatment had 100 per cent egg hatchability and no mortality was observed in the 48 hours after treatment (48HAT) (Table.5).

TABLE 5
Biosafety of the liquid fertiliser of the present
invention (Example 4) Nano N:P (1:2.5) against Green
lacewings Chrysoperla zastrowi sillemi eggs

| | | Dosage | Per cent egg | | |
|---|---|---|---|---|---|
| | | (Conc. of | hatchability | | Per cent |
| S. No. | Treatments | NDAP/litre) | (48HAT) | | mortality |
| 1 | (Example 4) | 2000 ppm | 100 | (88.83)^{a} | 0.00 |
| | (N:P 1:2.5) | | | | |
| 2 | (Example 4) | 4000 ppm | 99.62 | (86.46)^{b} | 0.38 |
| | (N:P 1:2.5) | | | | |
| 3 | (Example 4) | 6000 ppm | 99.12 | (84.61)^{c} | 0.82 |
| | (N:P 1:2.5) | | | | |
| 4 | (Example 4) | 8000 ppm | 98.75 | (83.58)^{bc} | 1.25 |
| | (N:P 1:2.5) | | | | |
| 5 | (Example 4) | 10000 ppm | 98.25 | (82.40)^{c} | 1.75 |
| | (N:P 1:2.5) | | | | |
| 6 | Untreated | — | 100 | (88.83)^{a} | 0.00 |

control

| | |
|---|---|
| S. Ed | 1.24 |
| C.D @0.5% level | 2.60 |
| C.V | 2.03 |

*mean values followed by alphabets are significantly different by DMRT (P = 0.05). ^{a, b, c and bc}denotes the difference in significance between the treatments.

Statistical analysis demonstrated that there is a significant difference between the two treatments. Similarly, 2000 ppm, 4000 ppm and 6000ppm of liquid fertilisers of the present invention with N:P (1:2.5), exhibited 0, 0.38, and 0.82 per cent mortality, and 100, 99.62, and 99.12 per cent egg hatchability, respectively, in the bio-safety study. The present study result showed that at 2000 ppm, 4000 ppm and 6000 ppm concentrations of the liquid fertiliser of the present invention (Example 4) N:P (1:2.5) with less than 1 per cent mortality was observed and no adverse effect was observed on Chrysoperla eggs in the crop ecosystem. The concentration of 8000 ppm of the liquid fertiliser of the present invention N:P (1:2.5) was found to cause 1.25 per cent mortality and 98.75 per cent egg hatchability.

### Biosafety of the Liquid Fertiliser of the Present Invention (Example 4) N:P (1:2.5) Against Indian Honeybee, Apis Cerana Indica

The Indian bee colonies were purchased from the Marutham honeybee farm in Kilakku Thottam, Nallampalayam, Coimbatore, Tamil Nadu and were later maintained at apiary unit at Thondamathur, Coimbatore, Tamil Nadu. The toxicity of the liquid fertiliser of the present invention (Example 4) N:P (1:2.5) to honeybees was assessed using the contact toxicity method. The liquid fertiliser of the present invention N:P (1:2.5) concentrations of 2000 ppm, 4000 ppm, 6000 ppm, 8000 ppm and 10000 ppm were prepared with distilled water, and an equal amount of honey solution was added as a feed to honeybees. Plastic containers with adequate perforations in the upper lid was used to provide proper ventilation to the bees. The solution was placed in a 2 ml Eppendorf tube, and a small hole was made at the bottom side to facilitate the feeding by honeybees. The honeybees were collected from the rearing apiary unit and kept in the refrigerator for one minute to calm them before being transferred to a plastic container loaded with the liquid fertiliser of the present invention (Example 4) N:P (1:2.5) plus honey solutions of various concentrations. The mortality of bees was recorded at 6, 12, and 24 hours after treatment. The per cent mortality of bees was worked out using the formula,

$$Per cent mortality of bees = \frac{Number of dead bees}{Total number of bees} \times 100$$

The data obtained from the laboratory experiments were analyzed in a completely randomized design. The data on mortality per cent were transformed into arc sine values. Further, the treatment means were statistically differentiated by performing Duncan Multiple Range Test (DMRT) at p<0.05 levels.

The toxicity of the the liquid fertiliser of the present invention N:P (1:2.5) was tested in vitro against the Indian honeybee, A. cerana indica, using different dilution ratios and the results are presented in Table.6. The toxicity result showed that 0, 2, and 3.25 percent mortality were recorded in the 6, 12, and 24 hours after treatment (HAT) at a concentration of 10000 ppm of the liquid fertiliser of the present invention N:P (1:2.5), whereas 0, 1, and 1.50 percent mortality were observed in the control. The statistical analysis revealed that there is a significant difference between the treatments. Similarly, the liquid formulation of the liquid fertiliser of the present invention (Example 4) N:P (1:2.5) at concentrations of 2000 and 4000 ppm revealed that no mortality was observed in the 6, 12, and 24 hours after treatment (HAT) whereas in the control group, 0, 1, and 1.5 per cent mortality were observed. The concentrations of 6000 and 8000 ppm of the liquid fertiliser of the present invention (Example 4) N:P (1:2.5) showed that 0, 0.75, 1.25, and 0, 2.0, and 3.25 per cent mortality were recorded at 6, 12, and 24 HAT, respectively. The above experimental results showed that the liquid fertiliser of the present invention (Example 4) N:P (1:2.5) is safe in the environment and has no harmful effect on pollinators like the Indian honeybee, A. cerana indica.

TABLE 6
Biosafety of liquid, fertiliser composition of the present invention
Example 4 N:P 1:2.5against Indian bees-Apis cerana indica

| | | Dosage | 6HAT | 12HAT | 24HAT |
|---|---|---|---|---|---|
| | | (Conc. of | Per cent | Per cent | Per cent |
| S. No. | Treatments | NDAP/liter) | mortality | mortality | mortality |
| 1 | (Example 4) | 2000 ppm | 0 | 0 | 0 |
| | (N:P 1:1.25) | | (1.16)^{a} | (1.16)^{a} | (1.16)^{a} |
| 2 | (Example 4) | 4000 ppm | 0 | 0 | 0 |
| | (N:P 1:1.25) | | (1.16)^{a} | (1.16)^{a} | (1.16)^{a} |
| 3 | (Example 4) | 6000 ppm | 0 | 0.75 | 1.25 |
| | (N:P 1:1.25) | | (1.16)^{a} | (4.96)^{b} | (7.60)^{b} |
| 4 | (Example 4) | 8000 ppm | 0 | 1.25 | 2.75 |
| | (N:P 1:1.25) | | (1.16)^{a} | (6.41)^{c} | (9.54)^{c} |
| 5 | (Example 4) | 10000 ppm | 0 | 2.00 | 3.25 |
| | (N:P 1:1.25) | | (1.16)^{a} | (8.13)^{d} | (10.38)^{d} |

| | | | | |
|---|---|---|---|---|
| 6 | Untreated control | 0 | 1.00 | 1.50 |

| | (1.16)^{a} | (5.73)^{b} | (7.03)^{a} |
|---|---|---|---|
| S. Ed | 0.00 | 1.47 | 0.84 |
| C.D @0.5% level | 0.00 | 3.09 | 1.70 |

*All the mean values followed by an alphabet are significantly different by DMRT (P = 0.05). ^{a, b, c and bc}denotes the difference in significance between the treatments.

### SUMMARY

The current stable liquid fertiliser compositions containing nano clusters of Nitrogen & Phosphorous containing fertiliser such as di-Ammonium Phosphate (DAP) are prepared using green technology having N:P ratio of 1:1 to 1:6 with a nitrogen content of 3 to 9% (w/w) and phosphorous content (as P₂O₅) 6% to 18% (w/w). The liquid fertiliser compositions of the present invention exhibit stability at temperatures up to 50° C. without gelling, phase separation and precipitation during storage. The hydrodynamic diameter of the particles is less than 100 nm, with pH ranging between 3 and 7. The liquid fertiliser compositions of the present invention increased the vigour index of major crops such as paddy, groundnut and green gram upon seed treatment. Further, the said fertilisers demonstrate significant photosynthetic activity and field efficacy in paddy. These fertilisers are eco-friendly as they are biosafe and do not exhibit any negative impact on beneficial organisms in agriculture such as parasitoids, predator and Indian honey bees.

1. A stable liquid fertiliser composition comprising nano clusters of Nitrogen and Phosphorous wherein the nitrogen is in the range of 3-9% (w/w) and phosphorous (expressed in terms of P₂O₅) is in the range of 6-18% (w/w), wherein the N:P (as P₂O₅) ratio ranges from 1:1 to 1:6, and wherein the average hydrodynamic diameter of the particles is less than 100 nm.

2. The stable liquid fertiliser composition as claimed in claim 1, wherein the pH ranges from 3-7.

3. The stable liquid fertiliser composition as claimed in claims 1-2, wherein the zeta potential is higher that −10 mV

4. The stable liquid fertiliser composition as claimed in claims 1-3, wherein the surface tension ranges from 25-30 N/m.

5. The stable liquid fertiliser composition as claimed in claims 1-4, wherein the contact angle of the spray solution on leaf surface is substantially <90°.

6. The stable liquid fertiliser composition as claimed in claims 1-5 wherein HLB values are in the range 10.0 to 13.0

7. A process for the preparation of stable liquid fertiliser composition comprising steps wherein
i) hydrolyzed aqueous solution of urea (4-15%) is reacted with a solution of mono ammonium phosphate (25-35%) in the presence of polyphosphates (1-3%),
ii) optionally adjusting the pH of the resulting solution to <4, iii) mixing a non-ionic surfactant or poly ether derivatives (0.3-1.5%) in the solution to obtain component 1;
iv) separately preparing a solution of a polymer (0.3-1.5%) and oligosaccharide (0.01-1%),
v) optionally adding of amino acid or vitamins to obtain component 2;
vi) mixing component 1 and component 2,
vii) optionally adding buffers, anti-microbial agents as preservatives and defoamers.

8. The process for the preparation of stable liquid fertiliser composition as claimed in claim 7, wherein hydrolysis of urea is achieved by sonication, thermally, enzymatically or by known means, preferably by sonication.

9. The process for the preparation of stable liquid fertiliser composition as claimed in claims 7-8, wherein the polyphosphate is preferably sodium tripolyphosphate.

10. The process for the preparation of stable liquid fertiliser composition as claimed in claims 7-9, wherein the non-ionic surfactant is preferably selected from polyethers and ethoxylated sorbitan surfactants alone or in combination.

11. The process for the preparation of stable liquid fertiliser composition as claimed in claim 7-10, wherein the polyethers are preferably selected from poly ethylene glycol and poly propylene glycol.

12. The process for the preparation of stable liquid fertiliser composition as claimed in claims 7-11, wherein the surfactants are preferably selected from polysorbate 20 and polysorbate 80.

13. The process for the preparation of stable liquid fertiliser composition as claimed in claims 7-12, wherein the polymers are preferably selected from gum arabic and pectin.

14. The process for the preparation of stable liquid fertiliser composition as claimed in claims 7-13, wherein the oligosaccharide is selected from beta-cyclodextrin and dextrose.

15. The process for the preparation of stable liquid fertiliser composition as claimed in claims 7-14, wherein the amino acids added are preferably selected from Glycine, Lysine and Glutamic acid.

16. The process for the preparation of stable liquid fertiliser composition a claimed in claims 7-15, wherein the vitamins are preferably selected from L-encorbic acid (vitamin C) and α-tocopherol (vitamin E).
